(19) United States
(12) Patent Application Publication
(10) Pub. No.: US 2015/0234889 A1
(43) Pub. Date: Aug. 20, 2015

(54) Systems and Methods for Selecting Geographic Locations for Use in Biasing Search Results

(71) Applicant: Google Inc., Mountain View, CA (US)

(72) Inventors: Krzysztof Duleba, Pfaffikon SZ (SZ); Finnegan Southey, San Francisco, CA (US)

(73) Assignee: Google Inc., Mountain View, CA (US)

(21) Appl. No.: 13/760,719

(22) Filed: Feb. 6, 2013

(51) Int. Cl. G06F 17/30

(52) U.S. Cl. CPC G06F 17/30424

(57) ABSTRACT

Embodiments include a computer-implemented method that includes identifying a plurality of geolocations associated with a user based on a plurality of received geolocation signals, receiving, from a user device, a search query from the user, selecting one of the plurality of geolocations as a query geolocation based on application of a plurality of rules in a predefined order, identifying a set of search query results responsive to the search query based at least in part on the query geolocation, and providing, to the user device, the set of search query results for display to the user.

### BACKGROUND OF THE INVENTION

1. Field of the Invention

Embodiments of this invention relate generally to search industries and, more particularly, to special purpose machines, systems, methods and computer instructions for biasing search results based on geographic locations.

2. Description of the Related Art

The Internet provides access to a large number of resources, including, for example, webpages, maps, articles, files, and the like. To locate resources on the Internet, persons often employ Internet searches or similar resource locating services. For example, a person may visit an Internet search website and submit a search query for “pizza restaurants” in hopes of locating nearby pizza restaurants. Search results often include a listing of resources that are related to the search query. For example, search results for the search query “pizza restaurants” may include a listing of webpages for pizza restaurants or the like. In some instances, the search results are ranked relative to one another based on their relevance to the search query. For example, a website for a pizza restaurant may be ranked above a website for a business that merely sells pizza ingredients. In some instances, the search results are ranked based on their physical proximity to a location associated with the search. For example, where the search query includes “new york city pizza restaurant”, websites for pizza restaurants in the New York City area may be ranked ahead websites for pizza restaurants located outside of the New York City area.

Unfortunately, determining a location to be associated with a search query can be difficult. In some instances, little or no information may be provided regarding a location to be associated with the search query. As a result, a set of search results may be ranked without the aid of location information. In other instances, location information relating to several different locations may be received, making it difficult to decipher which, if any, of the locations are relevant to the search query. As a result, an irrelevant location may be identified, which can skew a ranking of the search results.

### SUMMARY OF THE INVENTION

Various embodiments of methods and apparatus for biasing search results based on geographic locations are provided herein. In some embodiments, provided is a computer-implemented method that includes identifying a plurality of geolocations associated with a user based on a plurality of received geolocation signals, receiving, from a user device, a search query from the user, selecting one of the plurality of geolocations as a query geolocation based on application of a plurality of rules in a predefined order, identifying a set of search query results responsive to the search query based at least in part on the query geolocation, and providing, to the user device, the set of search query results for display to the user.

In some embodiments, provided is a system including one or more memories storing instructions and one or more processors coupled to the one or more memories and configured to execute the instructions stored thereon to perform the following steps: identifying a plurality of geolocations associated with a user based on a plurality of received geolocation signals, receiving, from a user device, a search query from the user, selecting one of the plurality of geolocations as a query geolocation based on application of a plurality of rules in a predefined order, identifying a set of search query results responsive to the search query based at least in part on the query geolocation, and providing, to the user device, the set of search query results for display to the user.

In some embodiments, provided is a non-transitory computer readable medium having program instructions stored thereon that are executable by a processor to cause the following steps: identifying a plurality of geolocations associated with a user based on a plurality of received geolocation signals, receiving, from a user device, a search query from the user, selecting one of the plurality of geolocations as a query geolocation based on application of a plurality of rules in a predefined order, identifying a set of search query results responsive to the search query based at least in part on the query geolocation, and providing, to the user device, the set of search query results for display to the user.

In some embodiments, provided is a computer-implemented method for associating a geolocation with a user. The method includes identifying at least one or more of the following based at least in part on a plurality of geolocation signals: a current geolocation including a geolocation of the user; a request geolocation including a geolocation associated with a subject of a query submitted by the user; an explicit-preferred geolocation including a geolocation provided by the user; a visited geolocation including a geolocation determined to have been previously visited by the user; an implicit-preferred geolocation including a geolocation identified based on past actions by the user; and a session geolocation including a geolocation associated with a subject of one or more queries submitted by the user during a current search session.

The method including associating a geolocation with the user based on one or more of the following conditions: (a) a request geolocation exists; (b) there are at least a first threshold number of queries submitted by the user in a first given period of time, at least one of the queries includes a geolocation, and at least a first threshold amount of the queries including a geolocation include a geolocation that is the same or similar to the current geolocation; (c) a topic of the search query corresponds to the visited geolocation; (d) there are at least a second threshold number of queries submitted by the user in a second given period of time, at least one of the queries includes a geolocation, and at least a second threshold amount of the queries including a geolocation include a geolocation that is the same or similar to the implicit-preferred geolocation, wherein the second threshold amount is less than the first threshold amount; (e) there are at least a third threshold number of queries submitted by the user in a third given period of time, at least one of the queries includes a geolocation, and at least a third threshold amount of the queries including a geolocation include a geolocation that is the same or similar to the explicit-preferred geolocation, wherein the third threshold amount is less than the second threshold amount; (f) a current geolocation of the user has changed by at least a threshold distance within a fourth given period of time, and the user has not changed the explicit-preferred geolocation since the current geolocation of the user has changed by at least the threshold distance; (g) an explicit-preferred geolocation exists; (h) an implicit-preferred geolocation exists; and (i) a current geolocation exists that satisfies a quality threshold.

Associating geolocation with the user includes at least one of the following: in response to determining that condition (a) is true, associating the request geolocation with the user; in response to determining that condition (a) is not true and that condition (b) is true, associating the current geolocation with the user; in response to determining that conditions (a) and (b) are not true and that condition (c) is true, associating the visited geolocation that corresponds to the search query with the user; in response to determining that conditions (a), (b) and (c) are not true and that condition (d) is true, associating the implicit-preferred geolocation with the user; in response to determining that conditions (a), (b), (c) and (d) are not true and that condition (e) is true, associating the explicit-preferred geolocation with the user; in response to determining that conditions (a), (b), (c), (d) and (e) are not true and that condition (f) is true, associating the current geolocation with the user; in response to determining that conditions (a), (b), (c), (d), (e) and (f) are not true and that condition (g) is true, associating the explicit-preferred geolocation with the user; in response to determining that conditions (a), (b), (c), (d), (e), (f) and (g) are not true and that condition (h) is true, associating the implicit-preferred geolocation with the user; and in response to determining that conditions (a), (b), (c), (d), (e), (f), (g) and (h) are not true and that condition (i) is true, associating the current geolocation with the user.

### BRIEF DESCRIPTION OF THE DRAWINGS

FIG. 1 is a flowchart that illustrates a method of identifying a plurality of candidate geolocations associated with a user in accordance with one or more embodiments of the present invention.

FIG. 2 is a flowchart that illustrates a method of identifying and displaying a set of search results in accordance with one or more embodiments of the present invention.

FIG. 3 is a flowchart that illustrates a method of selecting a query geolocation in accordance with one or more embodiments of the present invention.

FIG. 4 is a block diagram that illustrates a search query environment in accordance with one or more embodiments of the present invention.

FIG. 5 is a block diagram that illustrates an exemplary computer system in accordance with one or more embodiments of the present invention.

### DETAILED DESCRIPTION

As discussed in more detail below, provided are systems and methods for biasing search results, and more particularly to biasing search results based on a geographic location (“geolocation”) associated with a corresponding search query. In some embodiments, a plurality of geolocation signals indicative of one more geolocations associated with a user are received, a plurality of geolocations are identified based on the geolocation signals, and, in response to receiving a search query from the user, one of the geolocations is selected (e.g., based on the application of a predetermined set of rules), a set of search results is identified and ranked based at least in part on the selected geolocation, and the set of ranked search results are provided to the user (e.g., displayed in a search results webpage). Thus, the set of geolocation signals associated with a user can be used to identify a geolocation that is associated with the user, and the identified geolocation can be used to bias search results that are provided to the user.

In some embodiments, the geolocation signals include various forms of information that are indicative of a plurality of geolocations that can be associated with a user (“candidate geolocations”). Candidate geolocations may include, for example, one or more of the following: (1) a current geolocation; (2) a request geolocation; (3) an explicit-preferred geolocation; (4) a visited geolocation; (5) an implicit-preferred geolocation; and/or (6) a session geolocation.

A current geolocation may reflect a user's geolocation at or near the time of a corresponding search query. Accordingly, the position (e.g., geographic coordinates) of the user's mobile device at or near the time of a search query may be a geolocation signal indicative of the user's current geolocation being the position of the mobile device. A request geolocation may include a geolocation associated with a subject of a query submitted by the user. Accordingly, a search query that includes the string “new york city pizza” may be a request geolocation signal that is indicative of the request geolocation of New York City. An explicit-preferred geolocation may include a geolocation that is expressly identified by the user. Accordingly, selection of “New York City” as a preferred geolocation in a user's profile settings may be an explicit-preferred geolocation signal that is indicative of the explicit-preferred geolocation of New York City. A visited geolocation may include a geolocation previously visited by the user. Accordingly, information indicative of the user having been in in Newark, N.J. on the day preceding a search query may be a visited geolocation signal indicative of the visited geolocation of Newark. An implicit-preferred geolocation may include a geolocation identified based on historical actions by the user. Accordingly, repeated user refinement of his/her search queries to include the string “new york city” may be an implicit-preferred geolocation signal indicative of the implicit-preferred geolocation of New York City. A session geolocation may include a geolocation associated with the subject of one or more queries submitted by the user during a current user session. Accordingly, the user submitting, from their mobile device and within the last 15 minutes, a series of search queries, including, “taxi’, “new york city hotels”, and “pizza restaurants” may be a session geolocation signal indicative of the session geolocation of New York City.

In some embodiments, a predetermined set of rules are used to prioritize and select a candidate geolocation to be associated with a search query (a “query geolocation”). For example, a rule may require that, if a request geolocation exists, the request geolocation is to be selected as the query geolocation. Similar rules may be provided to dictate selection of the query geolocation based on a variety of conditions, including, for example, the existence of a current geolocation, a request geolocation, an explicit-preferred geolocation, a visited geolocation, an implicit-preferred geolocation, and/or a session geolocation.

An “Internet search” or “web search” may include a search that is employed by a user to locate resources on the Internet. An Internet search may include, for example, a free-text web search, a map-based web search or the like. Although certain embodiments are described herein with regard to free-text based web searches for the purpose of illustration, it will be appreciated that the same or similar techniques may be provided for any variety of searches, such as map-based searches, universal searches (i.e., searches that combine results from a plurality of different types of searches, such as, free-text searches, map-based searches and so forth), and the like. A free-text web search may include the use of user submitted search criteria, such as a text search string or similar query, to search the Internet for resources that match or are otherwise related thereto. A map-based web search may include the use of user submitted search criteria to search the Internet for resources relating to places (e.g., geolocations, business, landmarks, points of interest, etc.) that match or are otherwise related thereto. Search results that are identified are typically displayed to the user in a list, a map or similar presentation format. For example, the user may be presented with an ordered listing of a given number of the highest ranked search results of the set of search results (e.g., including links to webpages, maps, or other resources that correspond to the highest ranked search results).

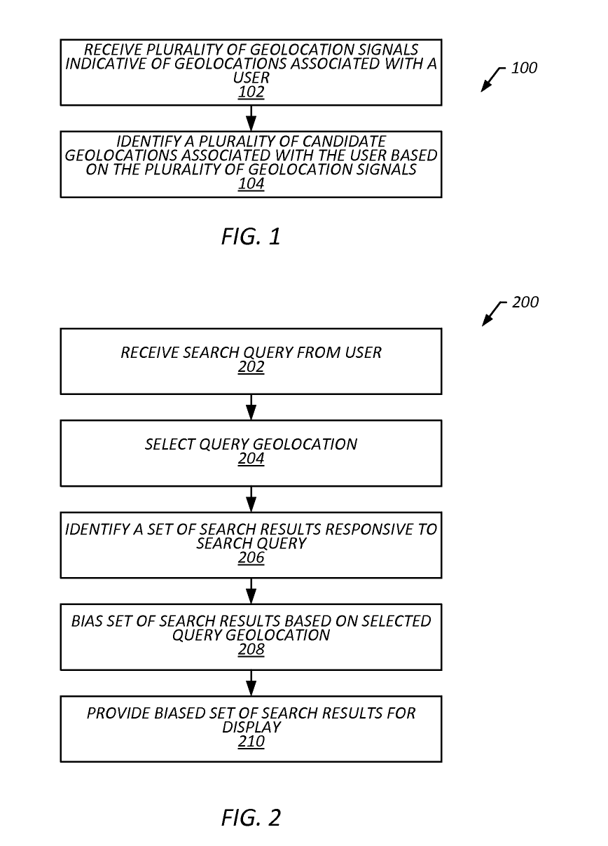

FIG. 1 is a flowchart that illustrates a method 100 of identifying a plurality of candidate geolocations associated with a user in accordance with one or more embodiments of the present invention. Method 100 may generally include receiving a plurality of geolocation signals indicative of one or more geolocations associated with a user, and identifying a plurality of geolocations associated with the user based on the plurality of geolocation signals. As discussed herein, one or more of the geolocations may be selected for use in biasing (e.g., ranking) search results that are ultimately provided to a user.

Method 100 may include receiving a plurality of geolocation signals indicative of one or more geolocations associated with a user (block 102). In some embodiments, receiving a plurality of geolocation signals includes receiving information indicative of a plurality of geolocations that can be associated with a user. For example, geolocation signals may include one or more of the following: (1) a current geolocation signal, (2) a request geolocation signal, (3) an explicit-preferred geolocation signal, (4) a visited geolocation signal, (5) an implicit-preferred geolocation signal, (6) a session geolocation signal, or the like.

Current geolocation signals may include information indicative of the user's current geolocation. In some embodiments, a current geolocation signal is indicative of the geolocation of a device employed by the user. For example, a current geolocation signal may include geolocation information for a network access geolocation (e.g., a geolocation of a Wi-Fi access point to which the device is connected), an IP geolocation (e.g., a geolocation associated with an IP address assigned to the device), or the like. As a further example, where a user employs a mobile device, such as a cellular phone, the current geolocation signal may include geographic coordinates (e.g., latitude and longitude coordinates) that are indicative of the geolocation of the mobile device and, thus, the user. Such geolocation information (i.e., geographic coordinates) may be provided by a global positioning system (GPS) device embedded in the mobile device and/or via other locating techniques, including, for example, triangulation between wireless access points.

Request geolocation signals may include information indicative of one or more geolocations that are associated with the subject of queries submitted by the user. For example, where a user searches for “new york city pizza” and “new york city hotels” the search strings “new york city pizza” and “new york city hotels” may be request geolocation signals indicative of the request geolocation of New York City.

Explicit-preferred geolocation signals may include geolocation information that is expressly identified by the user. For example, where the user selects “New York City” as their preferred geolocation in their user profile settings (e.g., user profile settings stored remotely by a content provider, locally on a user's device, or the like), the selection may be an explicit-preferred geolocation signals indicative of the explicit-preferred geolocation of New York City.

Visited geolocation signals may include information indicative of one or more geolocations previously visited by a user. For example, where historical geolocation information indicates that a user has visited Newark, the historical geolocation information may be visited geolocation signals indicative of the visited geolocation of Newark.

Implicit-preferred geolocation signals may include information indicative of historical actions by the user associated with one or more geolocations. For example, where the user repeatedly refines his/her search queries to include the string “new york city”, the refinements may be implicit-preferred geolocation signals indicative of the implicit-preferred geolocation of New York City.

Session geolocation signals may include information indicative of indicative of one or more geolocations that are associated with the subject of queries submitted by the user during a current user session (e.g., within a given period of time). For example, where a user searches for “taxi’, “new york city hotels”, and “pizza restaurants” within the last fifteen minutes, the search strings “taxi’, “new york city hotels”, and “pizza restaurants” may be session geolocation signals indicative of the session geolocation of New York City.

It will be appreciated that, in an effort to protect users' privacy, users may be made aware of the collection/use of geolocation signals and may be provided an opportunity to consent to collection/use of the geolocation signals and related data. Moreover, any geolocation signal data collected may be stored temporarily, and may be discarded after its use and/or a given period of time (e.g., three days). Further, geolocation data collected may not be tethered to an identifiable user. For example, any geolocation signal data collected may be used in the aggregate and/or may not be associated with an identifiable individual.

Method 100 may include identifying a plurality of candidate geolocations associated with the user based on the plurality of geolocation signals (block 104). In some embodiments, one or more of the geolocation signals received, such as those described with regard to block 102, are used to determine one or more candidate geolocations to be associated with the user. For example, identifying a plurality of candidate geolocations associated with the user based on the plurality of geolocation signals may include identifying one or more of the following candidate geolocations: (1) a current geolocation; (2) a request geolocation; (3) an explicit-preferred geolocation; (4) a visited geolocation; (5) an implicit-preferred geolocation; (6) a session geolocation, based on some or all of the geolocation signals received.

A current geolocation may include information indicative of the user's current geolocation. For example, the position (e.g., geographic coordinates) of the user's mobile device at or near the time of a search query (e.g., the search query described below with regard to block 202 of FIG. 2) may be identified as a current geolocation. A request geolocation may include a geolocation associated with a subject of a query submitted by the user. For example, New York City may be identified as a request geolocation where a search query (e.g., the search query described below with regard to block 202 of FIG. 2) includes the search string “new york city pizza”. An explicit-preferred geolocation may include a geolocation that is expressly identified by the user. For example, New York City may be identified as an explicit-preferred geolocation where the user selects “New York City” as their preferred geolocation in their user profile settings. A visited geolocation may include a geolocation previously visited by the user. For example, Newark may be identified as a visited geolocation it is determined that the user was in Newark on the day preceding a search query submitted by the user (e.g., the search query described below with regard to block 202 of FIG. 2). An implicit-preferred geolocation may include a geolocation identified based on historical actions by the user. For example, New York City may be identified as an implicit-preferred geolocation where the user repeatedly refines his/her search queries to include the sub-string “new york city”). A session geolocation may include a geolocation associated with the subject of one or more queries submitted by the user during a current user session. For example, New York City may be identified as a session geolocation where the user submitted, from their device and within the last fifteen minutes, a series of search queries, including, “taxi’, “new york city hotels”, and “pizza restaurants”.

As described herein, the plurality of candidate geolocations associated with the user may be employed to refine sets of search results that are provided to a user. For example, in response to receiving a search query associated with the user, one of the plurality of candidate geolocations associated with the user may be selected based on the application of a set of predefined rules, and the selected geolocation may be used to rank search results that are ultimately displayed to the user.

FIG. 2 is a flowchart that illustrates a method 200 of identifying and displaying a set of search results in accordance with one or more embodiments of the present invention. Method 200 may generally include receiving a search query from a user, selecting a query geolocation (e.g., from the candidate geolocations identified at block 104) based on the application of a predefined set of rules, identifying a set of search results responsive to the search query based at least in part on the selected query geolocation (e.g., including ranking the set of search results based on the query geolocation), and providing the set of search results for display (e.g., providing the set of search results for display to the user). Such a technique may provide for biasing (e.g., ranking) search results based on a geolocation that is expected to be of interest to the user.

Method 200 may include receiving a search query from a user (block 202). In some embodiments, receiving a search query from a user includes a search server receiving a search query submitted by a user. For example, a user may submit the search string “new york pizza restaurants” via a search application, such as a search webpage. The search query may be received by a search server that is tasked with servicing the search query.

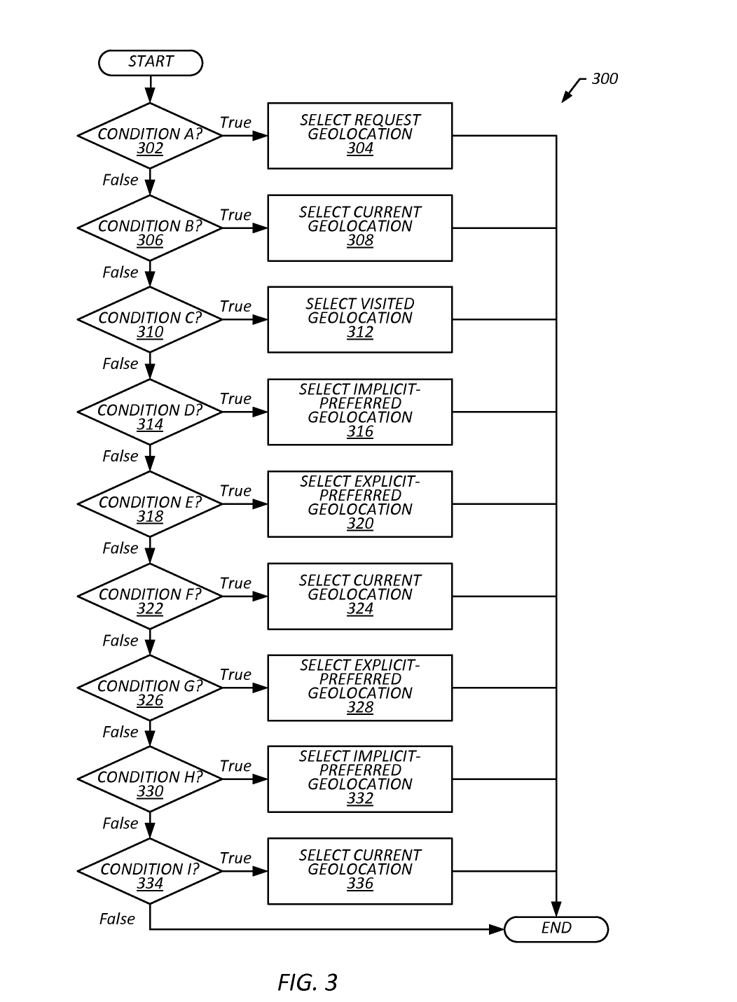

Method 200 may include selecting a query geolocation (block 204). In some embodiments, selecting a query geolocation includes selecting a query geolocation from a plurality of candidate geolocations (e.g., from the candidate geolocations identified at block 104) based on the application of a set of predefined rules. FIG. 3 is a flowchart that illustrates a method 300 of selecting a query geolocation in accordance with one or more embodiments of the present invention. As depicted, a particular candidate geolocation (e.g., a current geolocation, a request geolocation, an explicit-preferred geolocation, a visited geolocation, an implicit-preferred geolocation, or a session geolocation) may be selected based on a given set of conditions being satisfied.

In some embodiments, conditions to be considered include some or all of the following:
(a) a request geolocation exists (block 302);
(b) there are at least a first threshold number of queries submitted by the user in a first given period of time, at least one of the queries includes a geolocation, and at least a first threshold amount of the queries including a geolocation include a geolocation that is the same or similar to the current geolocation (block 306);
(c) a topic of the search query corresponds to the visited geolocation (block 310);
(d) there are at least a second threshold number of queries submitted by the user in a second given period of time, at least one of the queries includes a geolocation, and at least a second threshold amount of the queries including a geolocation include a geolocation that is the same or similar to the implicit-preferred geolocation, wherein the second threshold amount is less than the first threshold amount (block 314);
(e) there are at least a third threshold number of queries submitted by the user in a third given period of time, at least one of the queries includes a geolocation, and at least a third threshold amount of the queries including a geolocation include a geolocation that is the same or similar to the explicit-preferred geolocation, wherein the third threshold amount is less than the second threshold amount (block 318);
(f) a current geolocation of the user has changed by at least a threshold distance within a fourth given period of time, and the user has not changed the explicit-preferred geolocation since the current geolocation of the user has changed by at least the threshold distance (block 322);
(g) an explicit-preferred geolocation exists (block 326);
(h) an implicit-preferred geolocation exists (block 330); and
(i) a current geolocation exists that satisfies a quality threshold (block 334).

In some embodiments, condition “a” may be satisfied where the search query string includes a geographic location. For example, condition “a” may be satisfied where the search query includes the string “new york city pizza restaurants” based on the search string including the substring “new york city” which corresponds to the geolocation New York City. In such an embodiment (i.e., where condition “a” is satisfied), the request geolocation (e.g., New York City) may be selected as the query geolocation (block 304).

In some embodiments, condition “b” may be satisfied where the user submits at least a given number of queries within a given time frame (e.g., at least 5 queries within the preceding 15 minutes), at least one of the queries includes a geolocation (e.g., a substring “new york city”), and at least a given percentage (e.g., 75%) of the queries include a geolocation that is the same or similar to the current location. For example, condition “b” may be satisfied where the user submits six search queries within the 15 minutes prior to the submitting the current search query, two of the six queries include the substring “new york city”, and the current geolocation is determined to be New York City. In such an embodiment (i.e., where condition “b” is satisfied), the current geolocation (e.g., New York City) may be selected as the query geolocation (block 308).

In some embodiments, condition “c” may be satisfied where the search query string corresponds to a location visited by the user. For example, condition “c” may be satisfied where the search query includes the string “nets basketball” based on the topic of the search string (i.e., the new jersey nets basketball team) being associated with Newark, N.J., a geolocation determined to have been previously visited by the user. In such an embodiment (i.e., where condition “c” is satisfied), the visited geolocation (e.g., Newark, N.J.) may be selected as the query geolocation (block 312).

In some embodiments, condition “d” may be satisfied where the user submits at least a given number of queries within a given time frame (e.g., at least 5 queries within 15 minutes), at least one of the queries includes a geolocation (e.g., a substring “new york city”), and at least a given percentage (e.g., 50%) of the queries including a geolocation, include a geolocation that is the same or similar to the implicit-preferred geolocation. For example, condition “d” may be satisfied where the user submits six search queries within the 15 minutes prior to the submitting the current search query, one of the two queries including the substring “new york city” and the other of the two queries including the substring “san francisco”, and the implicit-preferred geolocation is determined to be New York City. In such an embodiment (i.e., where condition “d” is satisfied), the implicit-preferred geolocation (e.g., New York City) may be selected as the query geolocation (block 316).

In some embodiments, condition “e” may be satisfied where the user submits at least a given number of queries within a given time frame (e.g., at least 5 queries within 15 minutes), at least one of the queries includes a geolocation (e.g., a substring “new york city”), and at least a given percentage (e.g., 40%) of the queries including a geolocation, include a geolocation that is the same or similar to the explicit-preferred geolocation. For example, condition “d” may be satisfied where the user submits six search queries within the 15 minutes prior to the submitting the search query, one of the two queries including the substring “new york city” and the other of the two queries including the substring “san francisco”, and the explicit-preferred geolocation is determined to be New York City. In such an embodiment (i.e., where condition “e” is satisfied), the explicit-preferred geolocation (e.g., New York City) may be selected as the query geolocation (block 320).

In some embodiments, condition “f” may be satisfied where a current geolocation of the user has changed by at least threshold distance (e.g., 200 km) within a given period of time (e.g., 48 hours), and the user has not changed their explicit-preferred geolocation. For example, condition “f” may be satisfied where the user has flown from San Francisco to New York City, has been in New York City for three days, and the user has failed to change their user profile settings to include New York City as their preferred location. In such an embodiment (i.e., where condition “f” is satisfied), the current geolocation (e.g., New York City) may be selected as the query geolocation (block 324). Such an embodiment may help to automatically shift the query geolocation while the user is traveling and fails to update their user profile settings to reflect their current geolocation.

In some embodiments, condition “g” may be satisfied where an implicit-preferred geolocation exists. For example, condition “g” may be satisfied where the user has selected a preferred location of “new york city” in their user profile settings. In such an embodiment (i.e., where condition “g” is satisfied), the explicit-preferred geolocation (e.g., New York City) may be selected as the query geolocation (block 328).

In some embodiments, condition “h” may be satisfied where an implicit-preferred geolocation exists. For example, condition “h” may be satisfied where an implied preferred geolocation of “new york city” has been identified based on historical user actions. In such an embodiment (i.e., where condition “h” is satisfied), the implicit-preferred geolocation (e.g., New York City) may be selected as the query geolocation (block 332).

In some embodiments, condition “i” may be satisfied where a current geolocation exists that satisfies a minimum confidence threshold (e.g., 40%). For example, condition “i” may be satisfied where a current geolocation of “new york city” has been identified and has a confidence score above 40%. In such an embodiment (i.e., where condition “i” is satisfied), the current geolocation (e.g., New York City) may be selected as the query geolocation (block 336).

Although the illustrated embodiment includes an exemplary order for consideration of the conditions (e.g., first condition A, second condition B, and so forth) and a corresponding selection of a query geolocation, the order for consideration of the conditions may be modified in any suitable manner. For example, condition B may be considered before condition A, or the like. Such rearrangement may enable the conditions to be prioritized in any suitable manner. Moreover, one or more conditions may be removed from consideration or other conditions may be added.

Returning now to FIG. 2, method 200 may include identifying a set of search results responsive to the search query (block 206). In some embodiments, identifying a set of search results responsive to the search query includes identifying a plurality of search results that are related to the search query. For example, in response to the search query for “new york city pizza restaurants”, the search server servicing the query may identify a set of search results that includes search results corresponding to “The Chicago Pizza Parlor”, “The New York Restaurant”, “The Pizza Palace”, “Times Square Pizza”, and so forth.

Method 200 may include biasing the set of search results based at least in part on the query geolocation (block 208). In some embodiments, biasing the set of search results includes ranking the search results relative to one another based on a plurality of factors, such as relevance of the search result to the search string, proximity of the query geolocation to a geolocation associated with the search result, and so forth. In some instances, ranking includes scoring the search results based on the various factors, and ranking the search results based on the scoring. For example, a search result having a relatively high score may be ranked/ordered above one or more other search results having a relatively low score and vice versa. Thus, for example, where the query geolocation is New York City and ranking is based at least in part on a proximity of the query geolocation to a geolocation associated with the search result, a search result for a business located in or near New York City may experience a boost of its score/ranking, whereas a search result for a business that not located in or near New York City may experience a decrease in its score/ranking For example, where The Chicago Pizza Parlor is located in Chicago and each of The New York Restaurant, The Pizza Palace and Times Square Pizza are located in New York City, the search results for each of The New York Restaurant, The Pizza Palace and Times Square Pizza may receive a relative boost in their corresponding score/ranking (based at least in part on their geolocation being proximate to the query geolocation of New York City), whereas the search result for The Chicago Pizza Parlor may receive a relative decrease in its score/rank (based at least in part on it not being located in or near New York City). In such an instance, the search results may be provided in the following order (e.g., based at least in part on the adjusted score/ranking): “The New York Restaurant”, “The Pizza Palace”, “Times Square Pizza”, “The Chicago Pizza Parlor,” and so forth. Thus, search results that correspond to a geolocation proximate to, or otherwise associated with, the search query may be promoted within the set of search results.

Method 200 may include providing the biased set of search results for display (block 210). In some embodiments, providing the biased set of search results for display includes serving the ranked set of search results for display to the user. For example, upon identifying and ranking the search results (e.g., based at least in part on the identified query geolocation), the server may generate a search results webpage, including a given number (e.g., three) of the highest ranked search results of the ranked set of search results (e.g., “The New York Restaurant”, “The Pizza Palace”, “Times Square Pizza”), and serving the search results webpage for display to the user. Thus, for example, the search results webpage may include an ordered listing of search results for “The New York Restaurant”, “The Pizza Palace”, and “Times Square Pizza”. Although three search results have been discussed for the purpose of illustration, embodiments may include any number of search results provided in any suitable fashion. In some embodiments, for example, the search results page may include a listing of the ten highest ranked search results and/or a map having markers that correspond to geolocations of entities corresponding to one or more of the search results.

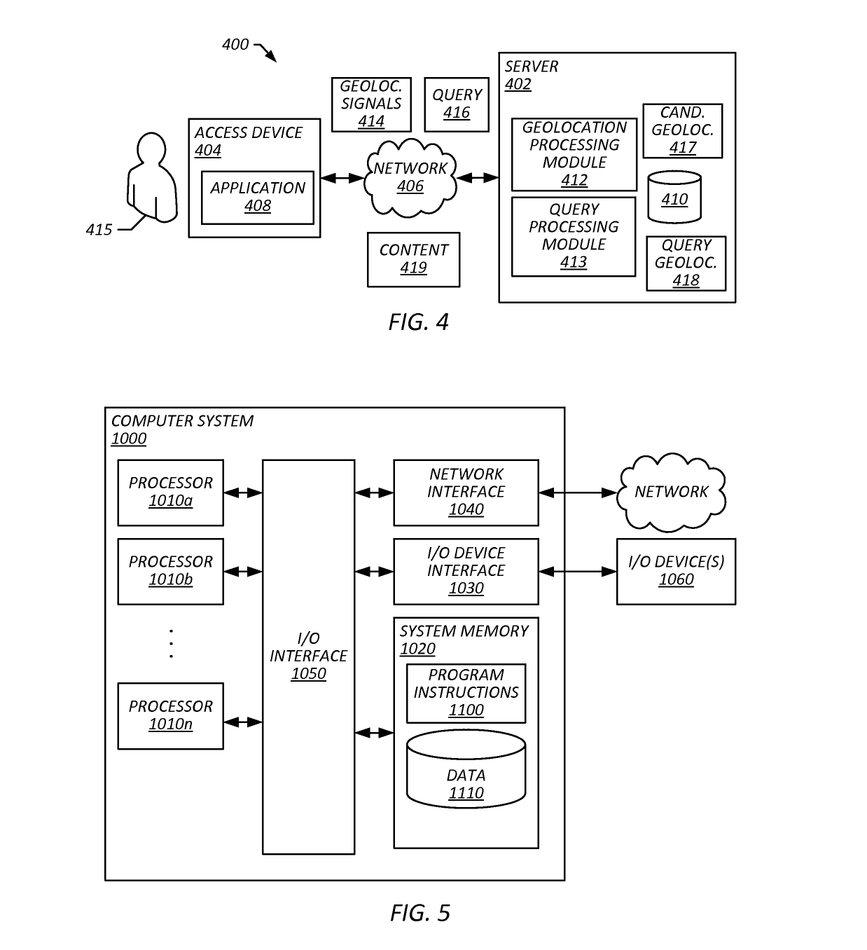

Methods 100, 200 and 300 are exemplary embodiments of techniques that may be employed in accordance with techniques described herein. Methods 100, 200 and 300 may be may be modified to facilitate variations of the implementations and uses. Methods 100, 200 and 300 may be implemented in software, hardware, or a combination thereof. Some or all of methods 100, 200 and 300 may be implemented by one or more of the modules/applications described herein, such as geolocation processing module 412, query processing module 413, and/or application 408 depicted and described in more detail below with regard to FIG. 4. For example, geolocation processing module 412 may implement some or all of the steps described with regard to method 100 and/or query processing module 413 may implement some or all of the steps described with regard to method 200 and/or method 300. The order of the steps of methods 100, 200 and 300 may be changed, and various elements may be added, reordered, combined, omitted, modified, etc.

FIG. 4 is a block diagram that illustrates a search query environment 400 in accordance with one or more embodiments of the present invention. In the illustrated embodiment, environment 400 includes a server 402 and an access devices 404 communicatively coupled via a network 406.

Network 406 may include an electronic communications network, such as the Internet, a local area network (LAN), a wide area (WAN), a cellular communications network or the like. Network 406 may include a single network or combination of networks.

Access device 404 may include any variety of electronic devices. For example, access device 404 may include a personal computer (e.g., a desktop computer), a mobile computing device (e.g., a laptop, tablet computer, a cellular phone, a personal digital assistant (PDA), etc.), or the like. In some embodiments, access device 404 is a client of server 402. In some embodiments, access device 404 includes various input/output (I/O) interfaces, such as a graphical user interface (e.g., display screen), an audible output user interface (e.g., speaker), an audible input user interface (e.g., microphone), a keyboard, a pointer/selection device (e.g., mouse, trackball, touchpad, touchscreen, stylus, etc.), a printer, or the like. In some embodiments, access device 404 includes general computing components and/or embedded systems optimized with specific components for performing specific tasks. In some embodiments, access device 404 includes one or more applications 408. In some embodiments, application 408 includes one or more modules having program instructions that are executable by a computer system to perform some or all of the functionality described herein with regard to access device 404. An application may include, for example, Internet browser (or similar application) that facilitates communication with server 402 and/or other entities of environment 400. In some embodiments, access device 404 includes a computer system similar to that of computer system 1000 described below with regard to at least FIG. 5.

Server 402 may include a network entity that serves requests by client entities. For example, server 402 may serve requests generated by access device 404. In some embodiments, server 402 hosts a content site, such as a website, a file transfer protocol (FTP) site, an Internet search website or other source of network content. In some embodiments, server 402 includes a search server (e.g., a search engine). In some instances, server 402 may serve webpages in response to request for webpage content generated by an Internet browser of access device 404. In some embodiments, server 402 includes or otherwise has access to a data store 410, such as a database or similar data repository.

In some embodiments, server 402 includes a geolocation processing module 412. In some embodiments, server 402 includes a query processing module 413. Geolocation processing module 412 and/or query processing module 413 may include program instructions that are executable by a computer system to perform some or all of the functionality described herein with regard to a server. For example, geolocation processing module 412 may include program instructions that are executable by a computer system to perform some or all of the steps of method 100. Query processing module 413 may include program instructions that are executable by a computer system to perform some or all of the steps of method 200 and 300. In some embodiments, server 402 includes a computer system similar to that of computer system 1000 described below with regard to at least FIG. 5. Although server 402 is represented by a single box in FIG. 4, server 402 may include a single server (or similar system), or a plurality of servers (and/or similar systems). For example, server 402 may include a plurality of different servers (and/or similar systems) that are employed individually or in combination to perform some or all of the functionality described herein with regard to server 402.

In some embodiments environment 400 employs some or all of the techniques described herein. For example, server 402 may receive (e.g., from access device 404 via network 406) one or more location signals (e.g., (1) a current geolocation signal, (2) a request geolocation signal, (3) an explicit-preferred geolocation signal, (4) a visited geolocation signal, (5) an implicit-preferred geolocation signal, (6) a session geolocation signal, or the like) 414 indicative of one or more geolocations that are associated with a user 415. In some embodiments, one more location signals 414 may be provided via one or more queries 416 submitted to server 402. For example, query 416 may be a search query including the search string “new york city pizza restaurants”, which, thus, includes a request geolocation signal corresponding to New York City. Geolocation processing module 412 may process the received geolocation signals 414 to identify one or more candidate geolocations 417 associated with user 415 (e.g., as described with regard to method 100). The one or more candidate geolocations 417 may be stored in data store 410. In response to receiving search query 416 from user 415, query processing module 413 may process the query to identify, rank and serve a set of search results responsive to the query (e.g., as described with regard to method 200 and/or method 300). Thus, for example, where query 414 includes a search query for “new york city pizza restaurants” submitted by user 415 via application 408 (e.g., an Internet browser) of access device 404, query processing module 413 may identify a query geolocation 418 (e.g., based on the candidate geolocations 417 and/or geolocation signals 414), identify and rank a set of search results responsive to the search query (e.g., based at least in part on the query geolocation 418), and serve corresponding content 419 (e.g., a search results webpage), to access device 404. Application 408 may, then, render content 419 for display to user 414. Thus, the set of geolocation signals associated with a user can be used to identify a geolocation that is associated with the user, and the identified geolocation can be used to bias search results that are provided to the user.

Exemplary Computer System

FIG. 5 is a block diagram that illustrates an exemplary computer system 1000 in accordance with one or more embodiments of the present invention. Various portions of systems and methods described herein, may include or be executed on one or more computer systems similar to system 1000. For example, server 402 and/or access device 404 may include a configuration similar to at least a portion of computer system 1000. Further, methods/processes/modules described herein (e.g., geolocation processing module 412, query processing module 413 and/or application 408) may be executed by one or more processing systems similar to that of computer system 1000.

Computer system 1000 may include one or more processors (e.g., processors 1010a-1010n) coupled to system memory 1020, an input/output I/O device interface 1030 and a network interface 1040 via an input/output (I/O) interface 1050. A processor may include a single processor device and/or a plurality of processor devices (e.g., distributed processors). A processor may be any suitable processor capable of executing/performing instructions. A processor may include a central processing unit (CPU) that carries out program instructions to perform the basic arithmetical, logical, and input/output operations of computer system 1000. A processor may include code (e.g., processor firmware, a protocol stack, a database management system, an operating system, or a combination thereof) that creates an execution environment for program instructions. A processor may include a programmable processor. A processor may include general and/or special purpose microprocessors. A processor may receive instructions and data from a memory (e.g., system memory 1020). Computer system 1000 may be a uni-processor system including one processor (e.g., processor 1010a), or a multi-processor system including any number of suitable processors (e.g., 1010a-1010n). Multiple processors may be employed to provide for parallel and/or sequential execution of one or more portions of the techniques described herein. Processes and logic flows described herein may be performed by one or more programmable processors executing one or more computer programs to perform functions by operating on input data and generating corresponding output. Processes and logic flows described herein may be performed by, and apparatus can also be implemented as, special purpose logic circuitry, e.g., an FPGA (field programmable gate array) or an ASIC (application specific integrated circuit). Computer system 1000 may include a computer system employing a plurality of computer systems (e.g., distributed computer systems) to implement various processing functions.

I/O device interface 1030 may provide an interface for connection of one or more I/O devices 1060 to computer system 1000. I/O devices may include any device that provides for receiving input (e.g., from a user) and/or providing output (e.g., to a user). I/O devices 1060 may include, for example, graphical user interface displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote geolocation. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area (WAN), a cellular communications network or the like.

System memory 1020 may be configured to store program instructions 1100 and/or data 1110. Program instructions 1100 may be executable by a processor (e.g., one or more of processors 1010a-1010n) to implement one or more embodiments of the present technique. Instructions 1100 may include modules of computer program instructions for implementing one or more techniques described herein with regard to various processing modules. Program instructions may include a computer program (also known as a program, software, software application, script, or code). A computer program may be written in any form of programming language, including compiled or interpreted languages, or declarative/procedural languages. A computer program may include a unit suitable for use in a computing environment, including as a stand-alone program, a module, a component, a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier. A tangible program carrier may include a propagated signal and/or a non-transitory computer readable storage medium. A propagated signal may include an artificially generated signal (e.g., a machine generated electrical, optical, or electromagnetic signal) having encoded information embedded therein. The propagated signal may be transmitted by a suitable transmitter device to and/or received by a suitable receiver device. A non-transitory computer readable storage medium may include a machine readable storage device, a machine readable storage substrate, a memory device, or any combination thereof, or the like. Non-transitory computer readable storage medium may include, non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium having program instructions stored thereon that are executable by a computer processor (e.g., one or more of processors 1010a-1010n) to cause some or all of the subject matter and the functional operations described herein. A memory (e.g., system memory 1020) may include a single memory device and/or a plurality of memory devices (e.g., distributed memory devices).

I/O interface 1050 may be configured to coordinate I/O traffic between processors 1010a-1010n, system memory 1020, network interface 1040, I/O devices 1060 and/or other peripheral devices. I/O interface 1050 may perform protocol, timing or other data transformations to convert data signals from one component (e.g., system memory 3020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000, or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices and/or software that may perform or otherwise provide for the performance of the techniques described herein. For example, computer system 1000 may include a desktop computer, a laptop computer, a tablet computer, a server device, a client device, a mobile telephone, a personal digital assistant (PDA), a mobile audio or video player, a game console, a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” may include a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

1. A computer-implemented method comprising:
identifying a plurality of geolocations associated with a user based on a plurality of received geolocation signals, the plurality of geolocations being different geolocations associated with the same user;
receiving, from a user device, a search query from the user;
obtaining a plurality of conditions for selecting one of the plurality of geolocations, wherein each condition, when satisfied, corresponds to one of the plurality of geolocations;
determining a priority for each of the plurality of conditions;
applying the plurality of conditions to the plurality of geolocations in a predefined order according to the determined priority for each condition including:
in response to determining that a first condition of the plurality of conditions having a first priority and corresponding to a first geolocation is not satisfied, determining that a second condition of the plurality of conditions having a second priority lower than the first priority is satisfied; and
selecting a second geolocation of the plurality of geolocations which corresponds to the second condition as a query geolocation, wherein the second geolocation is different from the first geolocation,
identifying a set of search query results responsive to the search query based at least in part on the query geolocation; and
providing, to the user device, the set of search query results for display to the user.

2. The method of claim 1, wherein the plurality of geolocations associated with the user include at least three of:
a current geolocation of the user;
a geolocation requested by the user in the query;
a geolocation explicitly identified by the user as a preferred geolocation;
a geolocation determined to have previously been visited by the user;
a geolocation implicitly identified as a preferred geolocation based on past actions by the user; and
a geolocation included in one or more previous queries submitted by the user during a current user session.

3-8. (canceled)

9. The method of claim 1, wherein identifying a set of search query results responsive to the search query based at least in part on the query geolocation comprises:
identifying a set of search query results responsive to the search query; and
ranking the set of search query results based at least in part on the query geolocation to generate a set of ranked search results, and
wherein providing the set of search query results for display to the user comprises providing the ranked set of search query results for display to the user.

10. The method of claim 1, wherein ranking the set of search query results based at least in part on the query geolocation to generate a set of ranked search results comprises adjusting a ranking of a search result based on proximity of a geolocation associated with the search result to the query geolocation.

11. The method of claim 2, wherein the plurality of conditions includes two or more of:
(a) the user requested a geolocation in the received search query;
(b) the user previously submitted a plurality of queries within a threshold period of time, wherein at least a first threshold number of the plurality of queries includes a same or similar geolocation as the current geolocation of the user;
(c) a topic of the search query corresponds to the geolocation determined to have previously been visited by the user;
(d) a second threshold number of the plurality of queries previously submitted by the user includes a same or similar geolocation as the geolocation implicitly identified as the preferred geolocation based on past actions by the user, wherein the second threshold number is less than the first threshold number; and
(e) a third threshold number of the plurality of queries previously submitted by the user includes a same or similar geolocation as the geolocation explicitly identified as the preferred geolocation by the user, wherein the third threshold number is less than the second threshold number.

12. (canceled)

13. A system comprising:
one or more memories storing instructions; and
one or more processors coupled to the one or more memories and configured to execute the instructions stored thereon to perform the following steps:
identifying a plurality of geolocations associated with a user based on a plurality of received geolocation signals, the plurality of geolocations being different geolocations associated with the same user;
receiving, from a user device, a search query from the user;
obtaining a plurality of conditions for selecting one of the plurality of geolocations, wherein each condition, when satisfied, corresponds to one of the plurality of geolocations;
determining a priority for each of the plurality of conditions;
applying the plurality of conditions to the plurality of geolocations in a predefined order according to the determined priority for each condition including:
in response to determining that a first condition of the plurality of conditions having a first priority and corresponding to a first geolocation is not satisfied, determining that a second condition of the plurality of conditions having a second priority lower than the first priority is satisfied; and
selecting a second geolocation of the plurality of geolocations which corresponds to the second condition as a query geolocation, wherein the second geolocation is different from the first geolocation,
identifying a set of search query results responsive to the search query based at least in part on the query geolocation; and
sending, to the user device, the set of search query results for display to the user.

14. A non-transitory computer readable medium comprising program instructions stored thereon that are executable by one or more processors to cause steps comprising:
identifying a plurality of geolocations associated with a user based on a plurality of received geolocation signals, the plurality of geolocations being different geolocations associated with the same user;
receiving, from a user device, a search query from the user;
obtaining a plurality of conditions for selecting one of the plurality of geolocations, wherein each condition, when satisfied, corresponds to one of the plurality of geolocations;
determining a priority for each of the plurality of conditions;
applying the plurality of conditions to the plurality of geolocations in a predefined order according to the determined priority for each condition including:
in response to determining that a first condition of the plurality of conditions having a first priority and corresponding to a first geolocation is not satisfied, determining that a second condition of the plurality of conditions having a second priority lower than the first priority is satisfied; and
selecting a second geolocation of the plurality of geolocations which corresponds to the second condition as a query geolocation, wherein the second geolocation is different from the first geolocation,
identifying a set of search query results responsive to the search query based at least in part on the query geolocation; and
providing, to the user device, the set of search query results for display to the user.

15-20. (canceled)

21. The method of claim 11, wherein the plurality of conditions further include two or more of:
(f) the current geolocation of the user has changed by at least a threshold distance, and the user has not explicitly identified another geolocation as the preferred location since the current geolocation of the user has changed by the threshold distance;
(g) a geolocation is explicitly identified by the user as the preferred geolocation;
(h) a geolocation is implicitly identified as the preferred geolocation based on past actions by the user; and
(i) the current geolocation of the user satisfies a quality threshold.

22. The method of claim 1, wherein the corresponding geolocation for a condition is selected as the query geolocation when the condition is a highest priority condition of the plurality of conditions that is satisfied.

23. The system of claim 13, wherein the plurality of geolocations associated with the user include at least three of:
a current geolocation of the user;
a geolocation requested by the user in a query;
a geolocation explicitly identified by the user as a preferred geolocation;
a geolocation determined to have previously been visited by the user;
a geolocation implicitly identified as a preferred geolocation based on past actions by the user; and
a geolocation included in one or more previous queries submitted by the user during a current user session.

24. The system of claim 23, wherein the plurality of conditions includes two or more of:
(a) the user requested a geolocation in the received search query;
(b) the user previously submitted a plurality of queries within a threshold period of time, wherein at least a first threshold number of the plurality of queries includes a same or similar geolocation as the current geolocation of the user; and
(c) a topic of the search query corresponds to the geolocation determined to have previously been visited by the user;
(d) a second threshold number of the plurality of queries previously submitted by the user includes a same or similar geolocation as the geolocation implicitly identified as the preferred geolocation based on past actions by the user, wherein the second threshold number is less than the first threshold number; and
(e) a third threshold number of the plurality of queries previously submitted by the user includes a same or similar geolocation as the geolocation explicitly identified as the preferred geolocation by the user, wherein the third threshold number is less than the second threshold number.

25. The system of claim 24, wherein the plurality of conditions further include two or more of:
(f) the current geolocation of the user has changed by at least a threshold distance, and the user has not explicitly identified another geolocation as the preferred location since the current geolocation of the user has changed by the threshold distance;
(g) a geolocation is explicitly identified by the user as the preferred geolocation;
(h) a geolocation is implicitly identified as the preferred geolocation based on past actions by the user; and
(i) the current geolocation of the user satisfies a quality threshold.

26. The system of claim 13, wherein identifying a set of search query results responsive to the search query based at least in part on the query geolocation comprises:
identifying a set of search query results responsive to the search query; and
ranking the set of search query results based at least in part on the query geolocation to generate a set of ranked search results, and
wherein providing the set of search query results for display to the user comprises providing the ranked set of search query results for display to the user.

27. The system of claim 13, wherein ranking the set of search query results based at least in part on the query geolocation to generate a set of ranked search results comprises adjusting a ranking of a search result based on proximity of a geolocation associated with the search result to the query geolocation.

28. The system of claim 13, wherein the corresponding geolocation for a condition is selected as the query geolocation when the condition is a highest priority condition of the plurality of conditions that is satisfied.

29. The non-transitory computer readable medium of claim 14, wherein the plurality of geolocations associated with the user include at least three of:
a current geolocation of the user;
a geolocation requested by the user in a query;
a geolocation explicitly identified by the user as a preferred geolocation;
a geolocation determined to have previously been visited by the user;
a geolocation implicitly identified as a preferred geolocation based on past actions by the user; and
a geolocation included in one or more previous queries submitted by the user during a current user session.

30. The non-transitory computer readable medium of claim 30, wherein the plurality of conditions includes two or more of:
(a) the user requested a geolocation in the received search query;
(b) the user previously submitted a plurality of queries within a threshold period of time, wherein at least a first threshold number of the plurality of queries includes a same or similar geolocation as the current geolocation of the user;
(c) a topic of the search query corresponds to the geolocation determined to have previously been visited by the user;
(d) a second threshold number of the plurality of queries previously submitted by the user includes a same or similar geolocation as the geolocation implicitly identified as the preferred geolocation based on past actions by the user, wherein the second threshold number is less than the first threshold number; and
(e) a third threshold number of the plurality of queries previously submitted by the user includes a same or similar geolocation as the geolocation explicitly identified as the preferred geolocation by the user, wherein the third threshold number is less than the second threshold number.

31. The non-transitory computer readable medium of claim 30, wherein the plurality of conditions further include one or more of:
(f) the current geolocation of the user has changed by at least a threshold distance, and the user has not explicitly identified another geolocation as the preferred location since the current geolocation of the user has changed by the threshold distance;
(g) a geolocation is explicitly identified by the user as the preferred geolocation;
(h) a geolocation is implicitly identified as the preferred geolocation based on past actions by the user; and
(i) the current geolocation of the user satisfies a quality threshold.

32. The non-transitory computer readable medium of claim 14, wherein identifying a set of search query results responsive to the search query based at least in part on the query geolocation comprises:
identifying a set of search query results responsive to the search query; and
ranking the set of search query results based at least in part on the query geolocation to generate a set of ranked search results, and
wherein providing the set of search query results for display to the user comprises providing the ranked set of search query results for display to the user.

33. The non-transitory computer readable medium of claim 14, wherein ranking the set of search query results based at least in part on the query geolocation to generate a set of ranked search results comprises adjusting a ranking of a search result based on proximity of a geolocation associated with the search result to the query geolocation.
